(19) United States
(12) Patent Application Publication
(10) Pub. No.: US 2009/0028553 A1
(43) Pub. Date: Jan. 29, 2009

(54) Method and apparatus of detecting abnormal behavior in a passive optical network (PON)

(76) Inventor: Moshe Oron, San Rafael, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/881,833

(22) Filed: Jul. 27, 2007

(51) Int. Cl. H04B 10/08

(52) U.S. Cl. 398/25

(57) ABSTRACT

Environmental conditions, such as temperature or wind load, may cause a fiber-optic link to expand or contract, resulting in upstream communications drift. Current methods compensate for such drift assuming it is caused by environmental conditions; however, these methods cannot determine abnormal behavior due to fiber faults that magnify the effect of environmental changes. An example embodiment of the invention provides a method and corresponding apparatus for detecting abnormal drift behavior in a passive optical network (PON) and may include monitoring a metric representative of drift of upstream communications for an optical network unit (ONU) in a PON. The example method may detect and report abnormal behavior in the PON that cannot be fully attributed to “normal” environmental conditions, and indicate a possible fiber cable fault. An ability to detect fiber link faults may allow a system operator to proactively maintain the physical fiber before service interruptions affect an end-user.

### BACKGROUND OF THE INVENTION

Increasing consumer and business demand for faster Internet connections has resulted in the deployment of fiber optic networks deeper into communications networks. System operators have begun to install fiber-optic networks in the “last mile” such that fiber-optic links may now be deployed to, for example, a consumer's home. Passive optical networks (PON) have emerged as a popular network architecture owing to their compelling economic advantages over other network architectures. Field power supplies are also eliminated because passive optical splitter/combiners are used in the network tree. In addition, a PON's point-to-multipoint architecture has a significant density advantage over the point-to-point copper connections they are beginning to replace.

However, point-to-multipoint network architectures are more difficult to troubleshoot, in part, because of a lack of active network elements within the tree, and the difficulty of performing diagnostic measurements necessary to isolate problems, such as fiber fault issues. As a result, it is more problematic to isolate faults and perform proactive maintenance tasks that could allow a system operator to reduce network outages and improve customer service. Furthermore, as fiber-optic transmission media gets deployed deeper into the network, the media may increasingly be subjected to a larger variety of environmental conditions and extremes that may impact communications accuracy.

### SUMMARY OF THE INVENTION

An example method and corresponding apparatus of detecting abnormal behavior in a passive optical network (PON) may include monitoring a metric representative of drift of upstream communications from an optical network unit (ONU) in a PON. The example method may detect abnormal behavior in the PON exceeding effects related to environmental conditions causing the drift in the PON as a function of the metric representative of the drift. The example method may further include reporting the abnormal behavior.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of a Passive Optical Network (PON) employing an example embodiment of the invention;

FIG. 2 is a network diagram of a PON employing an example embodiment of the invention illustrating example environmental conditions;

FIG. 3 is a block diagram of an example portion of a PON employing an example embodiment of the invention where an Optical Line Terminal (OLT) is configured to detect abnormal behavior in a PON;

FIG. 4 is a more detailed block diagram of a portion of a PON employing an example embodiment of the invention where an OLT or an Optical Network Unit (ONU) is configured to detect abnormal behavior in a PON;

FIG. 5 is a flow diagram performed in accordance with an example embodiment of the invention; and

FIGS. 6A, 6B, and 6C are flow diagrams illustrating actions performed in accordance with an example embodiment of the invention.

### DETAILED DESCRIPTION OF THE INVENTION

A description of example embodiments of the invention follows.

Network service providers are increasingly deploying fiber optic transmission media deeper and deeper into the network infrastructure. The result is that fiber optic media is beginning to replace copper twisted pair media in many applications. Consequently, fiber optic media is being exposed to a variety of environmental conditions not previously seen. Such conditions may include excessive heating due to, for example, solar load and/or fiber stretching due to excessive wind load. These issues present additional troubleshooting challenges that must be dealt with when communications problems need to be resolved.

Current industry practice, such as that described in the International Telecommunications Union-Telecommunication (ITU-T) G.983 and G.984 standard, is based on detecting alarm conditions at a BPON Transmission Convergence layer or Gigabit Passive Optical Network (G-PON) Transmission Convergence (GTC) layer. One issue with this approach is that alarms may not occur until user services have been completely interrupted, rather than being able to anticipate and proactively prevent service problems. Furthermore, because the G.983 and G.984 standard treat drift as a normal phenomenon, there are no alarms that indicate optical communication signals are excessively drifting.

One method described in ITU G.983/4 attempts to correct “expected” environmental issues by readjusting the arrival of upstream communications signals by, for example, increasing or decreasing equalization delay when upstream communication signals arrive earlier or later, respectively. However, this method cannot determine when the observed drift is not due to “abnormal” environmental changes, i.e., not explainable based on current fiber theory and models.

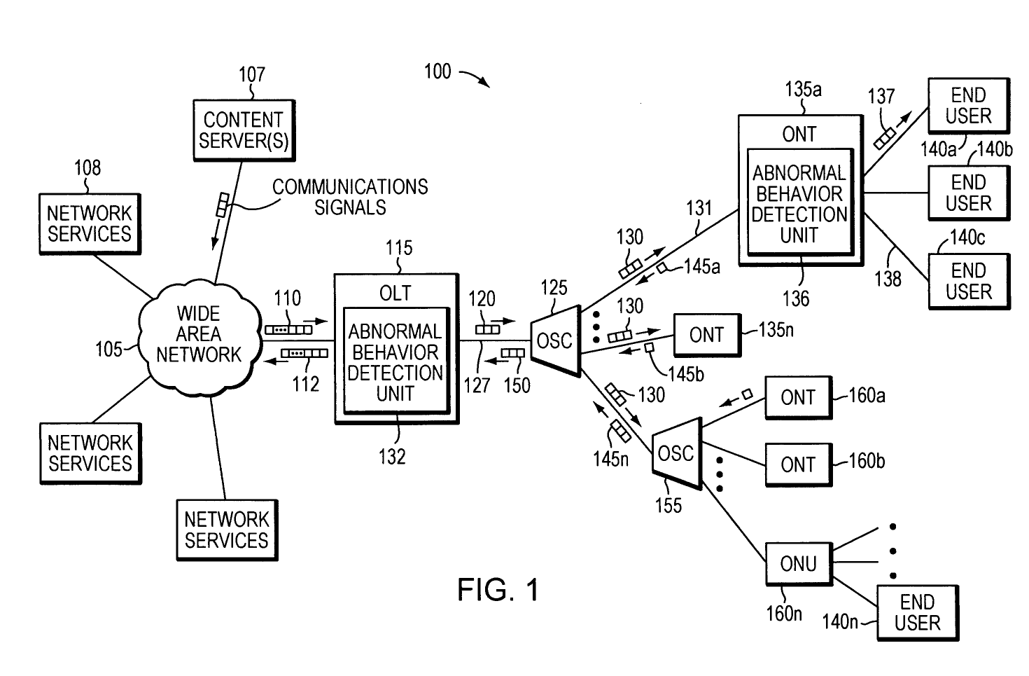

FIG. 1 is a network diagram of a passive optical network (PON) 100 illustrating aspects of an example embodiment of the invention. The PON 100 includes an optical line terminal (OLT) 115, a passive optical splitter/combiner (OSC) 125, and at least one optical network node, such as an optical network terminal (ONT) 135a-n or an optical network unit (ONU) 160n. Note that an ONU and an ONT may be used interchangeably unless indicated otherwise. Further note that “Data” as used herein refers to voice, video, analog, or digital data. The ONT 135a-n may be in optical communication with multiple end users 140a-n. Data communications 110 may be transmitted to the OLT 115 from a wide area network (WAN) 105. Content server(s) 107 or other network services 108 provide communications signals to and from the WAN 105.

Communication of downstream data 120 and upstream data 150 transmitted between the OLT 115 and the ONTs 135a-n may be performed using standard communications protocols known in the art. For example, multicast may be used to transmit the downstream data 120 from the OLT 115 to the ONTs 135a-n, and time division multiple access (TDMA) may be used to transmit the upstream data 150 from an individual ONT 135a-n back to the OLT 115. Note that the downstream data 120 is power divided by the OSC 125 into downstream data 130 matching the downstream data 120 “above” the OSC 125 but with power reduced proportionally to the number of paths onto which the OSC 125 divides the downstream data 120. It should be understood that the term downstream data (e.g., downstream data 120, 130) refers to optical traffic signals that travel from the OLT 115 to the ONT(s) 135a and end user(s) 140a-n, and “upstream data” (e.g., upstream data 145a, 150) refers to optical traffic signals that typically travel from the end users 140a-n and ONTs 135a-n to the OLT 115 via optical communications paths, such as optical fibers links 138, 131, 127.

The PON 100 may be deployed for fiber-to-the-premise (FTTP), fiber-to-the-curb (FTTC), fiber-to-the-node (FTTN), and other fiber-to-the-X (FTTX) applications. The optical fiber 127 in the PON 100 may operate at bandwidths such as 155 megabits per second (Mbps), 622 Mbps, 1.25 gigabits per second (Gbps), and 2.5 Gbps or other bandwidth implementations. The PON 100 may incorporate asynchronous transfer mode (ATM) communications, broadband services such as Ethernet access and video distribution, Ethernet point-to-multipoint topologies, and native communications of data and time division multiplex (TDM) formats or other communications suitable for a PON 100. End users 140a-n may receive and provide communications from and to, respectively, the PON 100 and may be connected to video devices, Ethernet units, digital subscriber lines, Internet Protocol telephones, computer terminals, wireless access, as well as any other conventional customer premise equipment.

The OLT 115 generates, or passes through, downstream communications 120 to an OSC 125. After flowing through the OSC 125, the downstream communications 120 are transmitted as power reduced downstream communications 130 to the ONTs 135 a-n, where each ONT 135a-n may filter and replicate data 130 intended for a particular end user 140a-c. The downstream communications 120 may also be transmitted to, for example, another OSC 155 where the downstream communications 120 are again split and transmitted to additional ONT(s) 160a-n and end user(s) 140n.

Data communications 137 may be further transmitted to and from, for example, end user(s) 140a-n in the form of voice, video, data, and/or telemetry over copper, fiber, or other suitable connection 138 as known to those skilled in the art. The ONTs 135a-n may transmit upstream communication signals 145a-n back to the OSC 125 via fiber connections 133 using transmission protocols known in the art, such as Internet Protocol (IP). The OSC 125, in turn, combines the ONT's 135a-n upstream signals 145a-n and transmits a combined signal 150 back to the OLT 115 which may, for example, employ a time division multiplex (TDM) protocol to determine from which ONTs 135a-n portions of the combined signal 150 are received. The OLT 115 may further transmit the communication signals 112 to a WAN 105.

Communications between the OLT 115 and the ONTs 135a-n occur using a downstream wavelength, for example 1490 nanometer (nm), and an upstream wavelength, for example of 1310 nm. The downstream communications 120 from the OLT 115 to the ONTs 135a-n may be provided at 2.488 Gbps, which is shared across all ONTs. The upstream communications 145a-n from the ONTs 135a-n to the OLT 115 may be provided at 1.244 Gbps, which is shared amongst all ONTs 135a-n connected to the OSC 125. Other communication data rates known in the art may also be employed.

The OLT 115 may contain an abnormal behavior detection unit 132, which may be used to detect communication problems due to, for example, fiber faults as a result of excessive heating and/or excessive wind load, according to an example embodiment of the invention. The ONU (i.e., ONT or ONU) may similarly contain an abnormal behavior detection unit 136 for detecting communications problems due to unexpected environmental conditions.

An example method and corresponding apparatus of detecting abnormal behavior in a passive optical network (PON) may include monitoring a metric representative of drift of upstream communications from an ONU in a PON. The example method may detect abnormal behavior in the PON unrelated to environmental conditions causing the drift as a function of the metric representative of the drift. The example method may further include reporting the abnormal behavior.

In an alternative embodiment, monitoring the metric may include observing the metric representative of drift based on timing differences between successive, periodic, or aperiodic upstream communications and may further include storing an accumulated drift metric. Monitoring the metric may also include observing equalization delay messages. Observing the equalization delay may include observing equalization delay messages at the ONU. Monitoring the metric may also include determining a rate or magnitude, individually or simultaneously, of the drift of the timing of upstream communications

In another example embodiment, the technique may include comparing the metric against a threshold. The threshold may be an absolute value of timing drift from a timing established by ranging the ONU from the OLT. Alternatively, the threshold may be a function of the metric and an identical metric of at least one other ONU in the PON or on the same optical distribution network (ODN) associated with the PON. The example embodiment may also include calculating the threshold as a variance of timing of multiple other ONUs in the PON or ODN in which reporting the abnormal behavior may include determining whether the metric is within or exceeds the variance.

In yet another example embodiment, the technique may report the abnormal behavior of the PON link to the ONU by sending an alarm or message to an Element Management System (EMS), or report the abnormal behavior of the link to the ONU by reporting information in an event the metric exceeds a threshold. Abnormal behavior is more likely indicative of a fiber fault, but may also be an optical transmitter fault, optical receiver fault, or the like. In the above described example embodiments, the ONU may be an optical network terminal (ONT) or an optical network unit (ONU) at, for example, a curb at a premises or similar FTTx application.

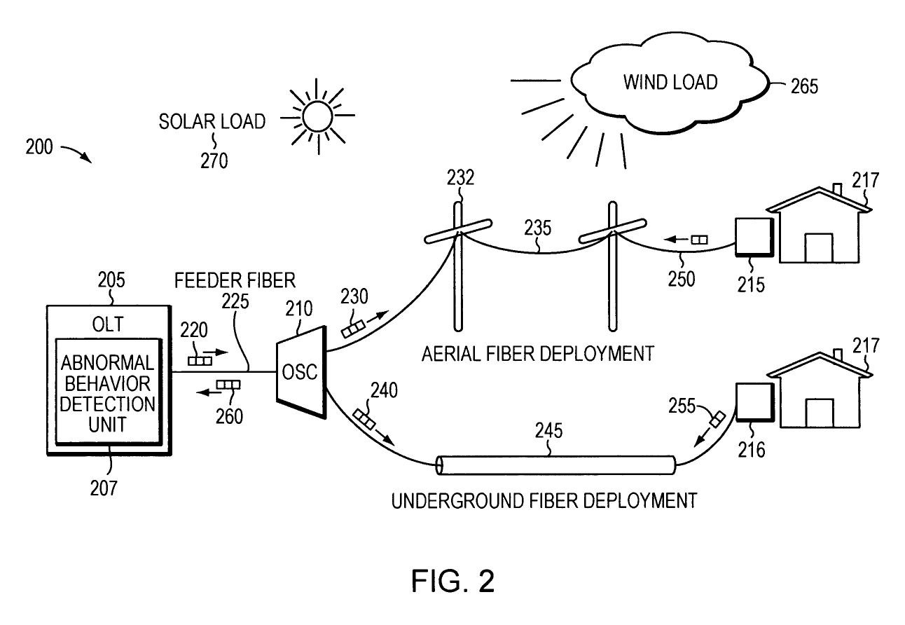

FIG. 2 is a network diagram of a PON 200 employing an example embodiment of the invention. The PON 200 contains an OLT 205, OSC 210, fiber links 235, 245, ONU 215, and end user 217. The OLT 205 may contain an abnormal behavior detection unit 207 to measure drift of upstream communications signals. Communications between the OLT 205 and the ONU 215 may be conducted in a same or similar manner as described in reference to FIG. 1. Communication signals 220 may be transmitted to and from the OLT 205 and the OSC 210 via feeder fiber 225. After being split by the OSC 210, communication signals continue to flow along fiber links 235, 245 to ONU 215 and 216 respectively. The fiber links 235 may be deployed in an aerial configuration, such as along utility poles 232 to ONU 215, or underground via the fiber link 245 to ONU 216.

As discussed above, solar load 270 may result in overheating of the aerial fiber link 235 such that the fiber may expand, resulting in a lengthening of the fiber. Alternatively, or in addition, wind load 265 may also cause the aerial fiber to stretch, lengthening the fiber 235, although to a lesser extent. The underground fiber 245 is less susceptible to both solar load 270 and wind load 265 but may also experience heating or cooling, which may cause the fiber 245 to increase or decrease in length. Thus, as the fiber 235 increases or decreases, upstream communications signals 250 may begin to drift and arrive at the OLT 205 sooner or later than expected.

Upstream communication signals 250 may be combined in a frame where each ONT 215 is allocated a particular slot where the slots need to be carefully synchronized. The synchronization process may be coordinated by the OLT 205, which transmits a downstream pulse 230 that arrives at the ONT every 125 μs. Upon arrival of the frame start at the ONTs, each ONT 215 may use the frame start as a reference to determine when to begin transmitting its upstream communications signal 250. To enable error-free communications, each ONT maintains an equalization delay value that determines how long the ONT should wait after receiving the frames before communicating its upstream signal. The equalization delay may be determined initially during ranging and may be subsequently readjusted by the OLT. This allows an orderly arrival of each ONT's communications signal at the OLT.

Drift of window (DoW) is a phenomena where, due to environmental changes, (e.g., temperature), the fiber expands or contracts, thus, changing the length of the fiber and, consequently, the distance between the OLT and the ONT. Because upstream communications require accurate equalization delays, a relatively small fiber expansion may require an equalization delay correction. For example, a 20 km fiber that stretches approximately 1 meter may require an equalization delay correction. As described above, DoW may be considered a normal event. The ITU G.983.1 and G.984.3 standard requires periodic drift monitoring and corrections to the ONT equalization delay values when drift occurs. However, the standard assumes that all equalization delay corrections are “normal.” The ITU standard does not provide a technique to identify abnormal DoW.

Abnormal DoW may indicate a fiber fault problem. A DoW for a particular ONU may be defined as abnormal when it exceeds a certain magnitude or rate of change relative to the fiber length and/or DoW of other ONU's on the same PON. Abnormal DoW may be used to troubleshoot fiber problems, such as physical fiber problems that make the fiber more vulnerable to solar load or wind load. Such information may allow a system operator to proactively identify and correct problems, and prevent further deterioration before user services are affected.

The ONT knows when the start frame signal was sent to the ONT and knows the equalization delay as well. Thus, the OLT knows exactly when the frame from the ONT should arrive at the OLT. If the frame arrives even one bit late, the OLT considers the upstream to have drifted. However, the ITU standard provides some additional guard-band so that a certain amount of drift is tolerable. Note that arrival times are typically defined as a number of bits; however, bits may easily be translated to time.

Expected changes in environmental conditions may cause occasional drift. The fiber cable structure and deployment practices are supposed to assure that the drift is minimal, and effects like solar and wind loads are kept to a reasonable level. However, a failure in the cable structure or bad deployment may expose the fiber to higher than expected effects. For example the fiber may overheat or twist due to high winds. Such effects shall indeed cause excessive drift. However, the system shall regard that as normal and keep performing the equalization delay corrections. Therefore detecting drift that builds up in magnitude or rate, for example, very quickly or frequently may indicate an error condition that is due to fiber faults,

One example embodiment of the invention monitors raw drift results or the correction values. Monitoring raw drift results may provide additional information in situations when drift may be increasing or decreasing but no correction is made (e.g., a threshold value was not crossed) and, therefore, is considered “normal.” Furthermore some systems may implement an aggressive threshold correction scheme in that they may not initiate a correction until the last-minute, i.e., just as collisions are about to occur. In this situation, there may be many drift events where equalization delay corrections are not necessary, but the information may still provide valuable troubleshooting data. In this way, the invention uses drift detection to troubleshoot fiber fault related communications problems.

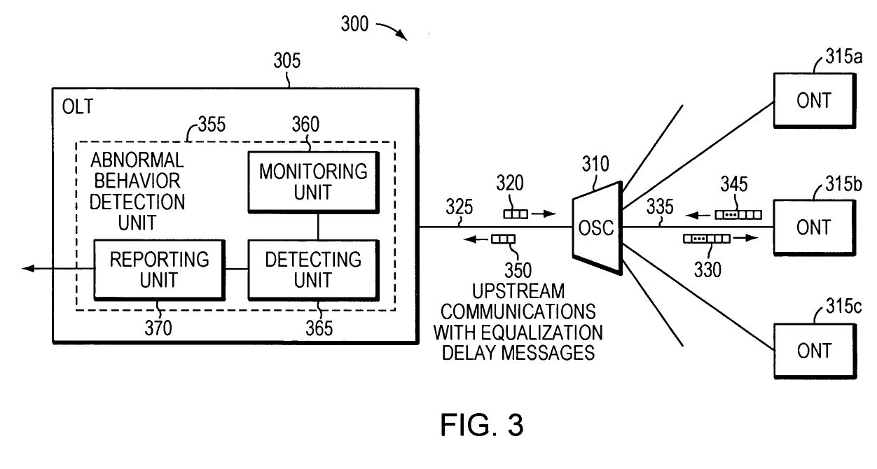

FIG. 3 is a block diagram of an example portion of a PON 300 employing an example embodiment of the invention. The PON 300 includes an OLT 305, OSC 310, and at least one ONT 315a-c. The OLT 305 includes an abnormal behavior detection unit 355 (see FIG.), which may include a monitoring unit 360, detecting unit 365, and reporting unit 370. Downstream communication signals 320 may be transmitted via feeder fiber link 325 to the OSC 310, where the signal 320 is split and continues to propagate to at least one ONU, such as the ONT 315a-c. The ONT 315a-c transmits upstream communication signals 345 back to the OSC 310, where the signals are combined and continue to flow upstream to the OLT 305. The downstream communications signals may contain equalization delay messages 350.

The monitoring unit 360 may monitor a metric representative of the drift of timing of the upstream communications signals. The detecting unit 365 may detect abnormal behavior in the PON 300 as a function of the metric representative of the drift. The reporting unit 370 may report the abnormal behavior, by, for example, reporting an alarm or message.

In operation, the OLT 305 may conduct an accurate equalization delay measurement to determine a value when an ONU is installed, reconnected, or reset. This value may be translated to the fiber distance for each ONT 315a-c, referred to herein as “Distance_i.” The measurement period may be defined as the time over which abnormal drift detection is performed, which may be in the order of a few hours to a few days, and may be predetermined or a configurable parameter, such as a value provided by a user. The total magnitude of the drift correction for an ONUi over the measurement period may be referred to herein as “cumulative-DoW-i.”

Thus, DoW-per-distance-I=cumulative-DoW-I/distance I

This value DoW-per-distance-I represents a magnitude of ONT drift over the measurement period, relative to the ONU distance. The limit on expected variance of DoW-per-distance across all ONU's on the same PON may be expressed by the term “DoW-variance-threshold.” An abnormal drift condition for an ONUi may be asserted when DoW-per-distance-I exceeds the allowed variance threshold. The variance calculation may use statistical formulas for standard deviation.

An alternative technique may simply compare the cumulative drift for each ONT against a threshold that defines the allowed drift/time/km. This may be useful, for example, in PONs with just a few ONTs. When an abnormal drift condition is detected, an alarm, report, or event may be sent to an EMS to provide maintenance and/or inspection suggestions for the abnormal fiber path.

Accordingly, the example embodiment of the invention takes distance into account since drift is proportional to distance because fiber expansion is proportional to distance, that is, a short fiber expands much less than a longer fiber.

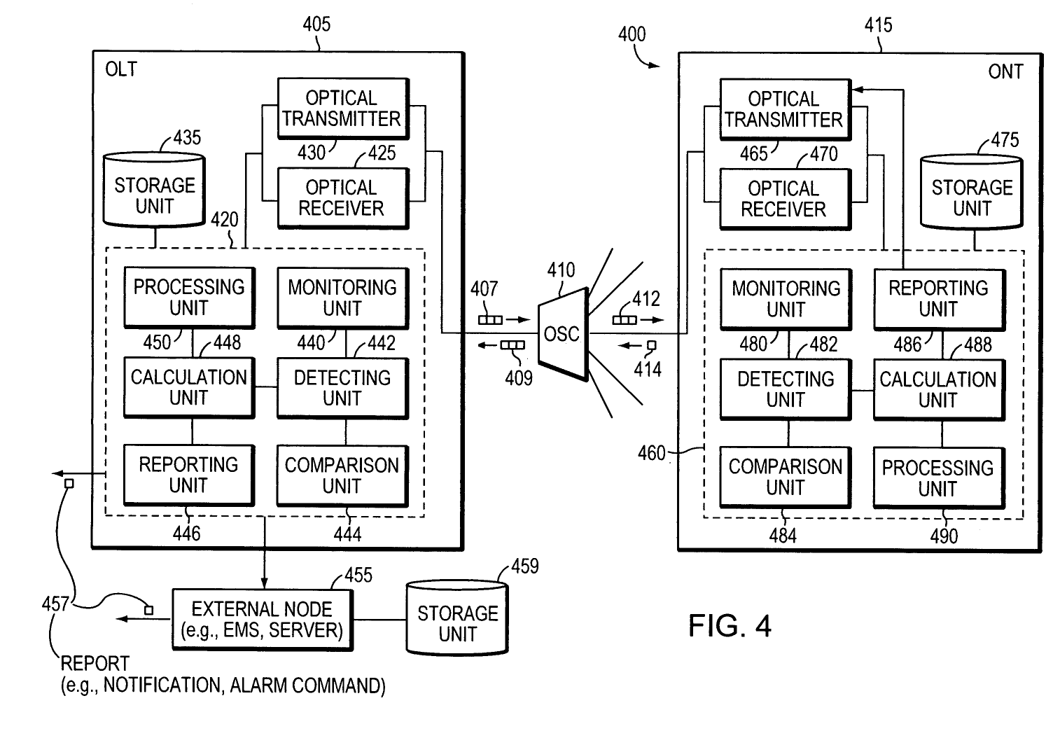

FIG. 4 is a more detailed block diagram of an example portion of the PON 400, according to an alternative example embodiment of the invention. The PON 400 includes an OLT 405, OSC 410, ONT 415, external node 455, and storage unit 459. The OLT may include an abnormal behavior detection unit 420, storage unit 435, optical transmitter 430, and optical receiver 425. The abnormal behavior detection unit 420 may include a monitoring unit 440, detection unit 442, comparison unit 444, reporting unit 446, calculation unit 448, and processing unit 450.

In this example embodiment, downstream communications 407 flow to the OSC 410, where they are split and flow further to multiple ONTs 415 (only one shown). The ONT 415 transmits upstream communication signals 414 back to the OSC 410. The OSC 410 combines upstream communication signals from all ONTs 415 connected to it into a frame for further transmission back to the OLT 405.

The upstream communications signal 409 may be received by the optical receiver 425, and may further propagate to the abnormal behavior detection unit 420. A metric representative of the drift may be monitored by the monitoring unit 440, which may observe the metric representative of drift based on timing differences between successive, periodic, or aperiodic upstream communications signals 409, and may further store an accumulated drift metric, which may be stored in, for example, a counter (not shown).

In an alternative embodiment, monitoring the metric may include determining a rate of drift or a magnitude of drift of the timing of upstream communications, and may be determined independently, sequentially, or simultaneously.

The detecting unit 442 may communicate the metric to the comparison unit 444, which may compare the metric against a threshold. In one embodiment, the threshold may be an absolute value of timing drift from a timing established by ranging the ONU from a node upstream of the ONU. Thus, the metric may be compared against a threshold independent of other ONUs.

Alternatively, the threshold may be a function of the metric and an identical metric of other ONUs in the PON. For example, the metric may be compared against an average metric of all, or a subset of, other ONUs on the PON. This embodiment may be particularly useful in PONs or optical distribution networks (ODN) in which the fiber links to the ONTs 415 are exposed to similar environmental conditions. Thus, the timing drift of one fiber link that varies significantly with respect to the other fiber links may indicate a fiber fault. In an alternative example embodiment, the calculation unit 448 may calculate the threshold as a variance of timing of multiple other ONUs in the same PON or ODN.

The reporting unit 446 may report abnormal behavior, such as determining whether the metric is within or exceeds the variance, and may include sending an alarm or message 457 to an external node, such as an element management system (EMS) or system operator (not shown). The reporting unit 446 may also report the abnormal behavior by reporting information if the metric exceeds a threshold, such as a user determined threshold. The results may be stored within a storage unit 435, 459 associated with the OLT 405 or the external node 455, respectively. The detected abnormal behavior may indicate fiber faults or other hardware problems, such as a faulty optical transmitter 430, 465 or optical receiver 425, 470.

Similarly, the ONU, such as the ONT 415, may also be configured to detect abnormal behavior in a PON. The ONT 415 may include an abnormal behavior detection unit 460, which may contain a monitoring unit 480, detecting unit 482, comparison unit 484, reporting unit 486, calculation unit 488, and processing unit 490. The monitoring unit 480 monitors may include observing equalization delay correction messages that may be embedded in the downstream communications signal 409 received at the OLT 405 or at another ONU (e.g., an ONT or ONU at a premises or at a curb). The monitoring unit may monitor also messages sent to other ONUs. The comparison unit 484 may compare the metric to an absolute threshold, or a threshold relative other ONTs (not shown) in the PON 400. The calculation unit 488 may calculate the threshold or parameter of at least one other ONT 415.

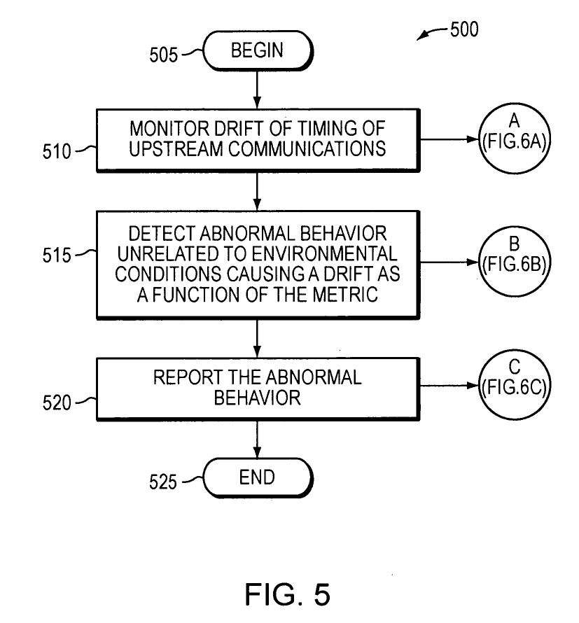

FIG. 5 is an example flow diagram of a process 500 illustrating an example embodiment of the invention. The process 500 begins (505) and monitors the drift of timing of an upstream communications signal (510). The process 500 may detect abnormal behavior causing the drift as a function of the metric (515). The process 500 may then report the abnormal behavior (520), such as issuing an alarm or variance report, and may then end (525).

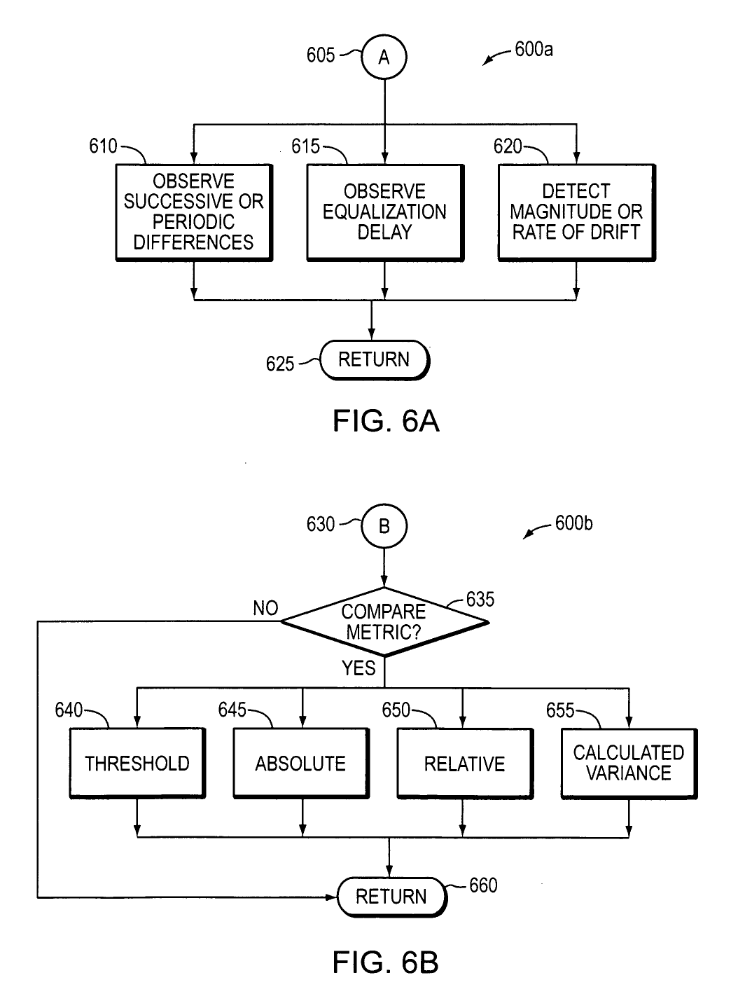

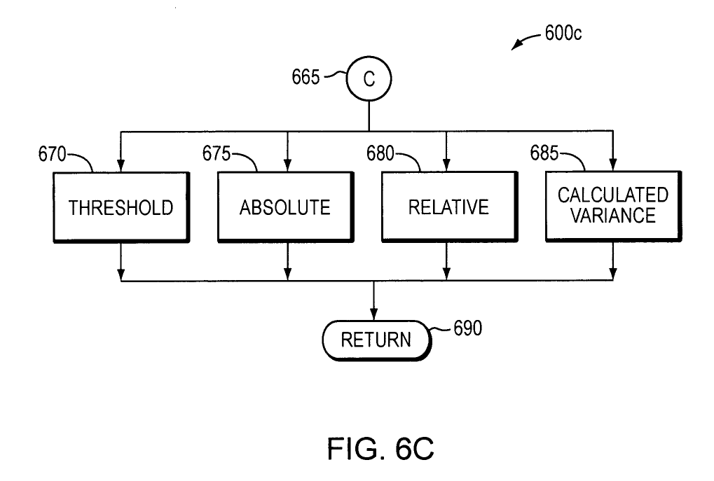

FIG. 6A is a flow diagram of a process 600a illustrating example embodiments of the invention. In one embodiment, the monitoring may begin (605) and may observe successive or periodic differences (610), unobserved equalization delays (615) at, for example, and OLT or ONU, or detect magnitude and/or rate of drift (620), and may then return (625) to the monitoring process 600 of FIG. 5.

FIG. 6B is a flow diagram of a process 600b according to another embodiment. The method may begin (630) by determining whether to compare a metric (635), and, if not, the comparing action returns (660). Otherwise the process continues and determines whether to compare a threshold (640), absolute threshold (645), relative threshold (650), or calculated variance (655). The process may then return (660) to the monitoring process 600 of FIG. 5.

FIG. 6c is a flow diagram of a process 600c according to another embodiment. A report process begins (665) and may report a metric that exceeds a threshold (670), absolute value (675), relative value (680), or calculated variance (685). The report process may then return (690) to the monitoring process 600 of FIG. 5.

Some or all of the flow 500 of FIG. 5 or flows 600a-c of FIG. 6 may be implemented in hardware, firmware, or software. If implemented in software, the software may be (i) stored locally with the OLT, the ONT, or some other remote location such as the EMS, or (ii) stored remotely and downloaded to the OLT, the ONT, or the EMS during, for example, start 505. The software may also be updated locally or remotely. To begin operations in a software implementation, the OLT, the ONT, or EMS may load and execute the software in any manner known in the art.

It should be apparent to those of ordinary skill in the art that methods involved in the invention may be embodied in a computer program product that includes a computer usable medium. For example, such a computer usable medium may consist of a read-only memory device, such as a CD-ROM disk or convention ROM devices, or a random access memory, such as a hard drive device or a computer diskette, having a computer readable program code stored thereon.

Although described in reference to a PON, the same or other example embodiments of the invention may be employed in an active optical network, data communications network, wireless network (e.g., between handheld communications units and a base transceiver station), or any other type of communications network.

While this invention has been particularly shown and described with references to example embodiments thereof, it will be understood by those skilled in the art that various changes in form and details may be made therein without departing from the scope of the invention encompassed by the appended claims.

What is claimed is:

1. A method of detecting abnormal behavior in a Passive Optical Network (PON), comprising:
monitoring a metric representative of drift of timing of upstream communications from an optical network unit (ONU) in a PON;
detecting abnormal behavior in the PON exceeding effects related to environmental conditions causing the drift in the PON as a function of the metric representative of the drift; and
reporting the abnormal behavior.

2. A method according to claim 1 wherein monitoring the metric includes observing the metric representative of drift based on timing differences between successive or periodic upstream communications.

3. A method according to claim 2 further including storing an accumulated drift metric.

4. A method according to claim 1 wherein monitoring the metric includes observing equalization delay messages.

5. A method according to claim 4 wherein observing the equalization delay includes observing equalization delay changes at an Optical Line Terminal (OLT).

6. A method according to claim 4 wherein observing the equalization delay includes observing equalization delay correction messages at the ONU.

7. A method according to claim 1 wherein monitoring the metric includes determining a rate or magnitude of the drift of the timing of upstream communications.

8. A method according to claim 1 wherein monitoring the metric includes determining a rate and magnitude, simultaneously, of the drift of timing of the upstream communications.

9. A method according to claim 1 further including comparing the metric against a threshold.

10. A method according to claim 9 wherein the threshold is an absolute value of timing drift from a timing established by ranging the ONU from the OLT.

11. A method according to claim 9 wherein the threshold is an absolute value of timing drift relative to the optical path distance between the ONU and the OLT.

12. A method according to claim 9 wherein the threshold is a function of the metric and an identical metric of at least one other ONU in the PON or on the same optical distribution network (ODN) associated with the PON.

13. A method according to claim 12 further including calculating the threshold as a variance of timing of multiple other ONUs in the PON or ODN and wherein reporting the abnormal behavior includes determining whether the metric is within or exceeds the variance.

14. A method according to claim 1 wherein reporting the abnormal behavior of the PON includes sending an alarm or message to an Element Management System (EMS).

15. A method according to claim 1 wherein reporting the abnormal behavior of the PON includes reporting information in an event the metric exceeds a threshold.

16. A method according to claim 1 wherein the abnormal behavior is indicative of a fiber fault.

17. A method according to claim 1 wherein the ONU is an optical network terminal (ONT) or an optical network unit (ONU) at a curb at a premises.

18. An apparatus for detecting abnormal behavior in a Passive Optical Network (PON), comprising:
a monitoring unit configured to monitor a metric representative of drift of timing of upstream communications from an optical network unit (ONU) in a PON;
a detecting unit configured to detect abnormal behavior of the PON unrelated to environmental conditions causing the drift in the PON as a function of the metric representative of the drift; and
a reporting unit configured to report the abnormal behavior.

19. An apparatus according to claim 18 wherein the monitoring unit is further configured to monitor the metric representative of drift based on timing differences between successive or periodic upstream communications.

20. An apparatus according to claim 19 further including a storage unit configured to store an accumulated drift metric.

21. An apparatus according to claim 18 wherein the monitoring unit is further configured to monitor equalization delay messages.

22. An apparatus according to claim 21 wherein the monitoring unit is configured to monitor equalization delay correction messages at the ONU.

23. An apparatus according to claim 18 wherein the monitoring unit is configured to determine a rate or magnitude of the drift of timing of upstream communications.

24. An apparatus according to claim 18 wherein the monitoring unit is configured to determine a rate and magnitude, simultaneously, of the drift of timing of the upstream communications.

25. An apparatus according to claim 18 further including a comparison unit configured to compare the metric against a threshold.

26. An apparatus according to claim 25 wherein the threshold is an absolute value of timing drift from a timing established by ranging the ONU from the OLT.

27. An apparatus according to claim 25 wherein the threshold is an value of timing drift relative to the optical path distance between the ONU and the OLT.

28. An apparatus according to claim 25 wherein the threshold is a function of the metric and an identical metric of at least one other ONU in the PON or on the same optical distribution network (ODN) associated with the PON.

29. An apparatus according to claim 26 further including a calculation unit configured to calculate the threshold as a variance of timing of multiple other ONUs in the PON or ODN and wherein the reporting unit is configured to report the abnormal behavior which includes determining whether the metric is within or exceeds the variance.

30. An apparatus according to claim 18 wherein the reporting unit is configured to send an alarm or message to an Element Management System (EMS).

31. An apparatus according to claim 18 wherein the reporting unit is configured to report information in an event the metric exceeds a threshold.

32. An apparatus according to claim 18 wherein the reporting unit is configured to report abnormal behavior indicative of at least one of the following: a fiber fault, an optical transmitter fault, or an optical receiver fault.

33. An apparatus according to claim 18 wherein the ONU is an optical network terminal (ONT) or an optical network unit (ONU) at a curb at a premises.
